(19) United States
(12) Patent Application Publication
(10) Pub. No.: US 2005/0247167 A1
(43) Pub. Date: Nov. 10, 2005

(54) Sliding pawl ratcheting wrench

(75) Inventors: Peter C. Chaconas, Glyndon, MD (US); Robert L. Arnold, Wrightsville, PA (US)

Correspondence Address: Kyle M. Globerman;Nelson Mullins Riley & Scarborough, L.L.P., 1320 Main Street, Columbia, SC, 29201, US

(73) Assignee: Easco Hand Tools, Inc.

(21) Appl. No.: 11/174,928

(22) Filed: Jul. 5, 2005

Related U.S. Application Data
(63) Continuation of application No. 10/437,860, filed on May 14, 2003, now abandoned.

(51) Int. Cl. B25B 13/46

(52) U.S. Cl. 81/63.2

(57) ABSTRACT

A ratchet wrench having three openings in the head. A gear, a pawl and a reversing lever are disposed respectively in the openings. The pawl is connected by at least one spring to the reversing lever. The reversing lever is detented and rotatably movable between two predetermined positions. Movement of the reversing lever moves the pawl through engagement of the spring to a first or a second position in the head. The pawl pivots within the second opening to drive or ratchet the wrench.

### CLAIM OF PRIORITY

The present application is a continuation of U.S. patent application Ser. No. 10/437,860, filed May 14, 2003, the entire disclosure of which is hereby being incorporated by reference in its entirety.

### FIELD OF THE INVENTION

The present invention relates to a ratchet wrench having a sliding pawl and more particularly to a sliding pawl connected by at least one spring to a lever arm for forward and reverse ratcheting.

### BACKGROUND OF THE INVENTION

Many types of ratchet wrenches are known that have a ratchet gear and an engaging pawl. In many, the pawl defines a front face with teeth that engage teeth on the ratchet gear on alternating sides, depending on the direction of rotation. The pawl may include a pair of pockets located in the back of the pawl, and the pawl is usually disposed in a cavity in the wrench head. A detent disposed in the wrench handle is in operative engagement with the pawl pockets and a reversing lever so that, as the reversing lever is moved from one position to another, the detent shifts between the pawl pockets to move the pawl from one side of the gear to the other. It is also known to have two individual pawls that are activated by spring(s), for example such as those disclosed in U.S. Pat. No. 533,386 to Upshaw, U.S. Pat. No. 1,053,703 to Bonnie, and U.S. Pat. No. 3,436,992 to Over et al. Springs are also used to drive pawls in U.S. Pat. No. 893,097 to Reams and U.S. Pat. No. 4,497,227 to Stasiek.

Wrenches having other types of pawls are also known. U.S. Pat. No. 1,209,320 to Momeweck discloses a pivoted pawl with separate springs connected to opposite ends of the pawl. The springs are connected to a cross lead that is rotated to reverse direction of the drive. U.S. Pat. No. 1,244,596 to Gealy discloses a pawl connected to a contraction spring. The spring encircles the wrench and is removably connected to the wrench. U.S. Pat. No. 1,981,526 to Rueb discloses a ratchet wrench having a triangular pawl with teeth and compression springs. U.S. Pat. Nos. 2,957,377 and 3,019,682 to Hare discloses a reversible ratchet-type wrench having a wedge-shaped pawl and a coil spring that is received in an opening in the pawl. In U.S. Pat. No. 3,265,171 to Kilness, a wedge-shaped pawl has a centrally-positioned hole in the back face of the pawl. In one embodiment a control pin and, in another embodiment, a dual diameter spring is received in the pawl hole. U.S. Pat. No. 4,497,227 to Stasiek discloses a square pawl with a compression spring in a radial plane above the pawl. An end of the spring is received in a bore in the pawl.

### BRIEF SUMMARY OF THE INVENTION

The present invention recognizes and addresses considerations of prior art constructions and methods and provides a ratcheting wrench comprising a handle and a head connected thereto, the head comprising a first circular opening therein, a second opening in communication with the first opening, the second opening defined by a wall, and a third opening in communication with the second opening. The wrench further includes a gear defining a plurality of teeth around a circumference thereof, and a pawl comprising a plurality of teeth formed on a front face, a recessed back wall opposite the front face, and a first connector and a second connector formed on the back wall, wherein the pawl teeth engage the gear teeth. A reversing lever is received by the third opening, wherein the reversing lever defines a connector proximate to the pawl. A detent is received in a blind bore formed in one of the third opening and the reversing lever and is in operative engagement with a first recessed pocket formed in the other of the third opening and the reversing lever. A spring connects the lever connector to the first and the second pawl connectors. In this configuration, rotation of the reversing lever to a first position where the detent engages the first pocket causes the spring to bias the pawl into engagement with a first portion of the second opening wall. Moreover, at least a first portion of the pawl teeth engage the gear teeth so that rotation of the handle in a first direction drives the gear in the first direction and rotation of the handle in a second direction causes the gear teeth to ratchet over the pawl teeth.

The accompanying drawings, which are incorporated in and constitute a part of this specification, illustrate one or more embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended drawings, in which:

FIG. 1 is a partial perspective view of a ratchet wrench according to an embodiment of the present invention;

FIG. 2 is an exploded view of the wrench of FIG. 1;

FIG. 3 is a top plan view of the ratchet wrench of FIG. 1;

FIG. 4 is a cross-sectional view taken across the lines 4-4 in FIG. 18.

FIG. 5 is a perspective view of a pawl for use in the ratchet wrench of FIG. 1;

FIG. 6 is a top plan view of the pawl in FIG. 5.

FIG. 7 is a front view of the pawl of FIG. 5;

FIG. 8 is a rear view of the pawl of FIG. 5;

FIG. 9 is a side view of the pawl of FIG. 5;

FIG. 10 is a perspective view of a reversing lever for use in the ratchet wrench of FIG. 1;

FIG. 11 is a bottom plan view of the reversing lever of FIG. 10;

FIG. 12 is a side elevation view of the reversing lever of FIG. 10;

FIG. 13 is a front elevation view of the reversing lever of FIG. 10;

FIG. 14 is a rear elevation view of the reversing lever of FIG. 10;

FIG. 15 is a top plan view of the ratcheting wrench of FIG. 1, with the reversing lever moved to a first predetermined position;

FIG. 16 is a top plan view of the ratchet wrench of FIG. 15 with the wrench handle rotated in the clockwise direction;

FIG. 17 is a top plan view of the ratcheting wrench of FIG. 1, with the reversing lever moved to a second predetermined position;

FIG. 18 is a top plan view of the ratcheting wrench of FIG. 17, with the wrench handle rotated in the counterclockwise direction;

FIG. 19 is a partial top plan view of a ratchet wrench in accordance with an embodiment of the present invention;

FIG. 20 is an exploded view of a ratcheting wrench in accordance with an embodiment of the present invention;

FIG. 21 is a partial top plan view of the wrench of FIG. 20;

FIG. 22 is a top plan view of a pawl for use in the wrench of FIG. 20;

FIG. 23 is a perspective view of the pawl for use in the ratchet wrench of FIG. 20.

FIG. 24 is a top plan view of a gear ring for use in the wrench of FIG. 20;
Each of FIGS. 25 and 25A is a side view, partly in section, of the ratchet gear and release button for use in the wrench of FIG. 20;

FIG. 26 is a top view of components of a wrench during a design procedure in accordance with an embodiment of the present invention;

FIG. 26A is an enlarged view of a portion of the components shown in FIG. 26;

FIG. 27A is a partial top plan view of an embodiment of the present invention;

FIG. 27B is a cross-sectional view of the wrench shown in FIG. 27A;

FIG. 28 is a partial perspective view of a gear ring in accordance with an embodiment of the present invention;

FIG. 29 is a partial perspective view of a pawl in accordance with an embodiment of the present invention; and

FIG. 30 is a partial top plan view of a ratcheting wrench in accordance with an embodiment of the present invention.

Repeat use of reference characters in the present specification and drawings is intended to represent same or analogous features or elements of the invention.

### DESCRIPTION OF THE PREFERRED EMBODIMENT

Reference will now be made in detail to presently preferred embodiments of the invention, one or more examples of which are illustrated in the accompanying drawings. Each example is provided by way of explanation of the invention, not limitation of the invention. In fact, it will be apparent to those skilled in the art that modifications and variations can be made in the present invention without departing from the scope and spirit thereof. For instance, features illustrated or described as part of one embodiment may be used on another embodiment to yield a still further embodiment. Thus, it is intended that the present invention covers such modifications and variations as come within the scope of the appended claims and their equivalents.

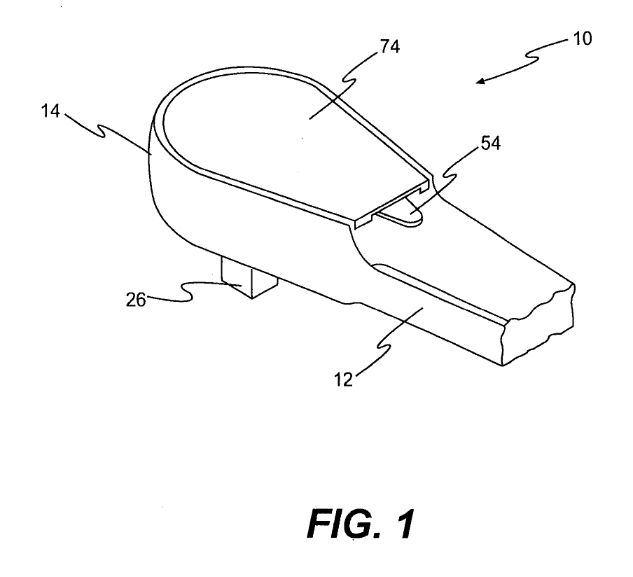

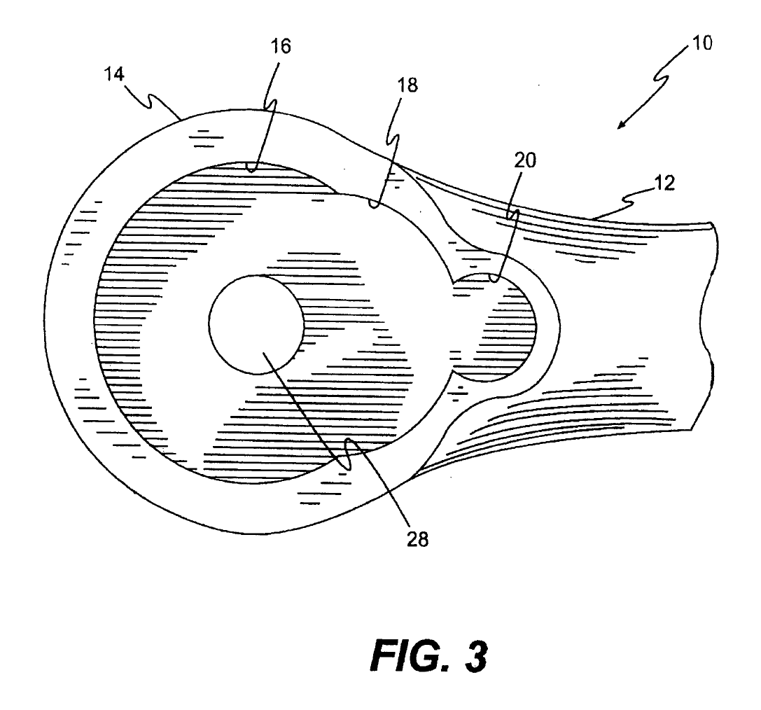

Referring to FIGS. 1-4, a ratcheting tool 10 includes an elongated arm, which may be formed as a handle 12 from stainless steel, metal alloys or other suitable materials. The length of handle 12 may vary depending on the application of ratcheting tool 10. A head 14 extends from the handle 12, and the head and handle may be integrally formed from the same material. The head has three openings formed therein (FIG. 3). The first is a substantially circular opening 16 located distal from handle 12. A second opening 18 opens into circular opening 16 and is intermediate the first opening and a third opening 20. Third opening 20, located proximate to handle 12, is substantially circular and opens into second opening 18.

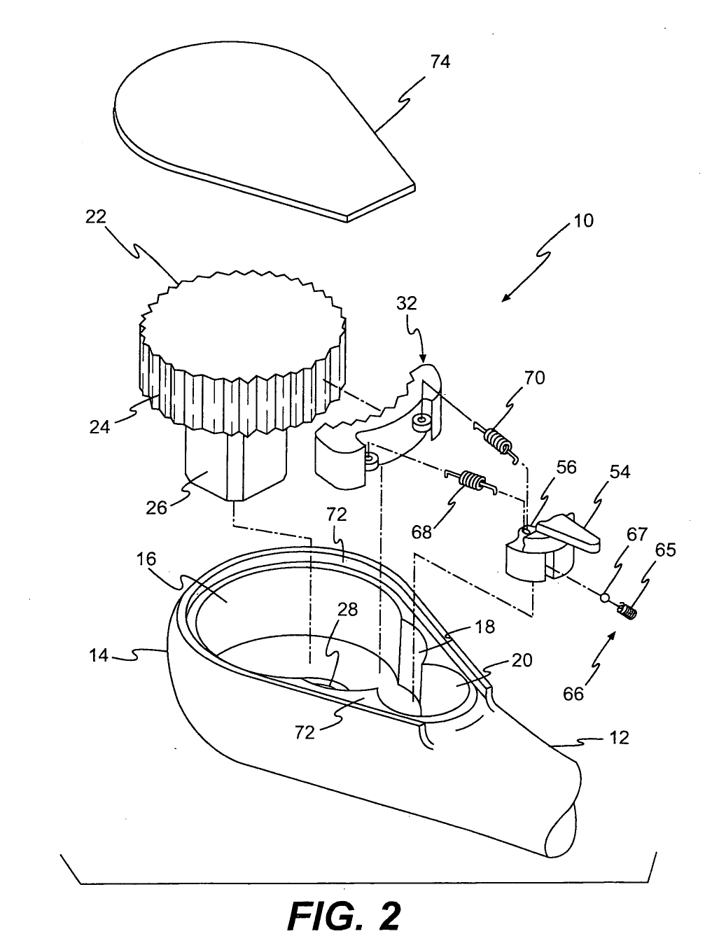

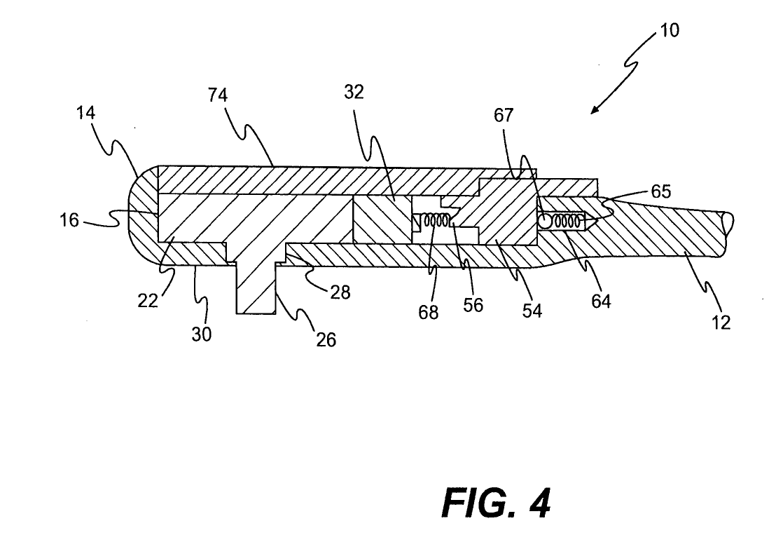

FIGS. 2 and 4 disclose an annular gear ring 22 having a plurality of equi-spaced teeth 24 that are formed about the gear's outer circumference. Gear 22 is disposed in circular opening 16 and includes a drive tang 26 formed thereon and extending outwardly from the bottom of the gear. Tang 26 extends through a hole 28 formed through a face 30 of head 14.

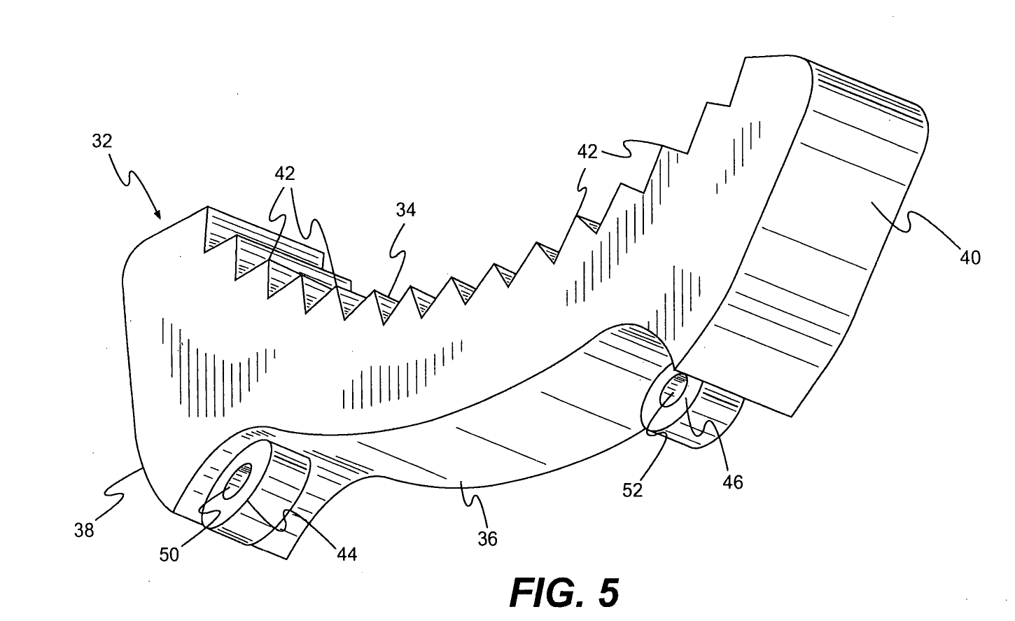

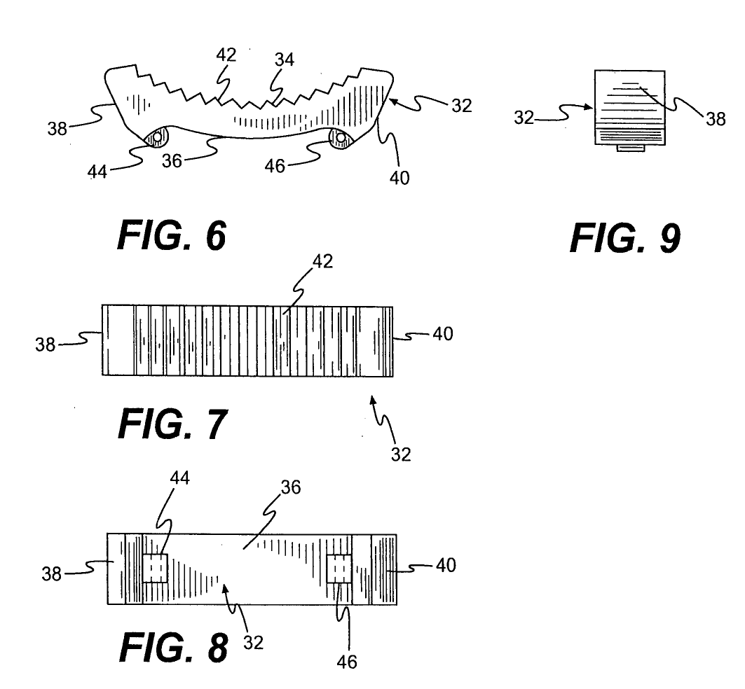

The gear ring is in operative engagement with a pawl 32 through cooperation of the teeth formed on each of the pawl and the gear ring. Referring to FIGS. 5-9, pawl 32 has a concave front face 34 with respect to its length and an opposite rear face 36, which preferably is recessed. Pawl 32 also includes sides 38 and 40 between front face 34 and rear face 36. The pawl's front face 34 defines a plurality of equi-spaced-apart teeth 42, which cooperate with the gear teeth. Two connectors 44 and 46 are formed on the pawl's rear face 36 and are preferably spaced apart so that connector 44 is nearer to pawl side 38 and the other connector 46 is nearer to pawl side 40. The space between the connectors may vary depending on the pawl design. Each of connectors 44 and 46 may be an upright pin or a flange containing an opening. Preferably, connectors 44 and 46 are annularly extending flanges each defining an opening 50 and 52, respectively. Pawl 32 is positioned in second opening 18 (FIG. 4) so that the pawl and gear teeth engage each other.

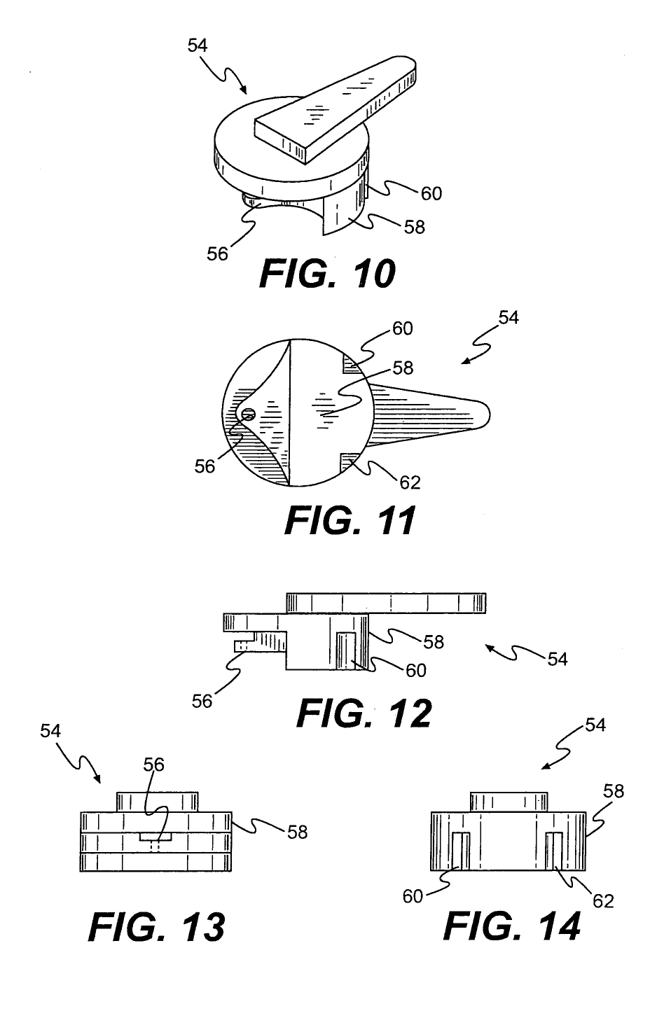

FIGS. 10 to 14 illustrate a reversing lever 54 that is rotatably disposed in third opening 20 (FIGS. 2 and 4). Reversing lever 54 defines a connector 56 formed in the front face of the reversing lever (FIGS. 4, and 10-13). Connector 56 is in the form of a flange containing an opening, but may also be a flange and pin (not shown). The connector is preferably located at the approximate midpoint of the front face of a lever portion 58.

Reversing lever 54 also defines a pair of separated pockets 60 and 62 located opposite from connector 56 in the rear face of portion 58, as shown in FIGS. 11 and 14, that are in operative engagement with a detent 66 (FIG. 2) disposed in handle 12. Handle 12 defines a blind bore 64 (FIG. 4.) that receives the detent, whereby the detent may engage reversing lever pockets 60 and 62 to position reversing lever 54 into a first and a second predetermined position. Referring to FIGS. 2 and 15-19, detent 66 includes a spring 65 and ball 67 but may be formed from a spring and pusher or other detent mechanisms that cause an outwardly biased structure to engage a pocket.

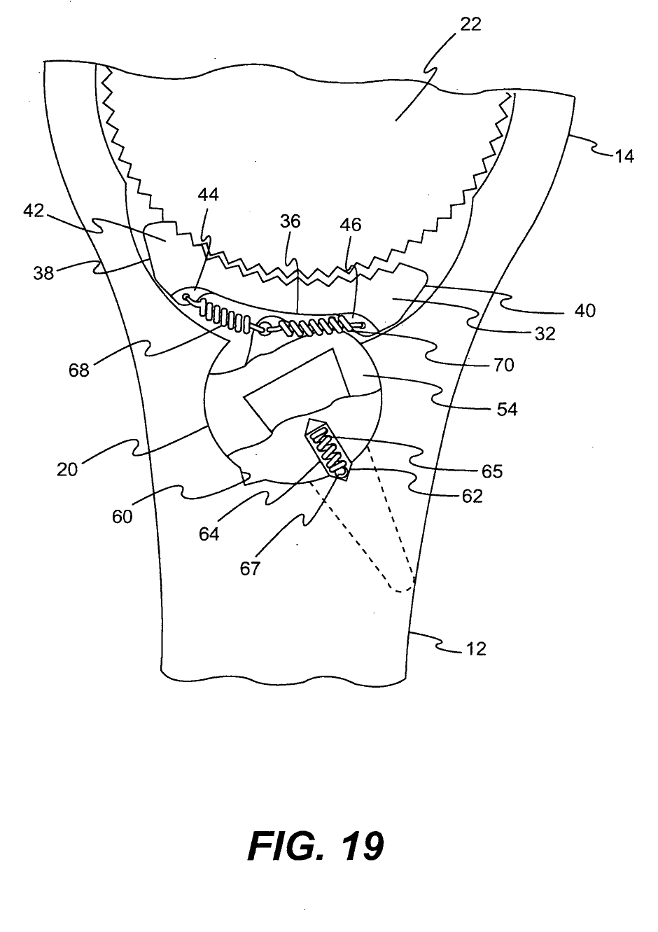

In an alternate embodiment (FIG. 19), reversing lever 54 defines blind bore 64 that receives spring 65 and ball 67. The walls of opening 20 define spaced-apart pockets 60 and 62 proximate handle 12. This eliminates tolerance problems that may be associated with accurately forming bore 64 in handle 12 in proper alignment with pockets 60 and 62. The pockets can easily be formed in the walls of opening 20, while bore 64 can be accurately formed in reversing lever 54. In either embodiment, however, reversing lever 54 may rotate between the first predetermined position and the second predetermined position by engagement of detent 66 with pockets 60 and 62.

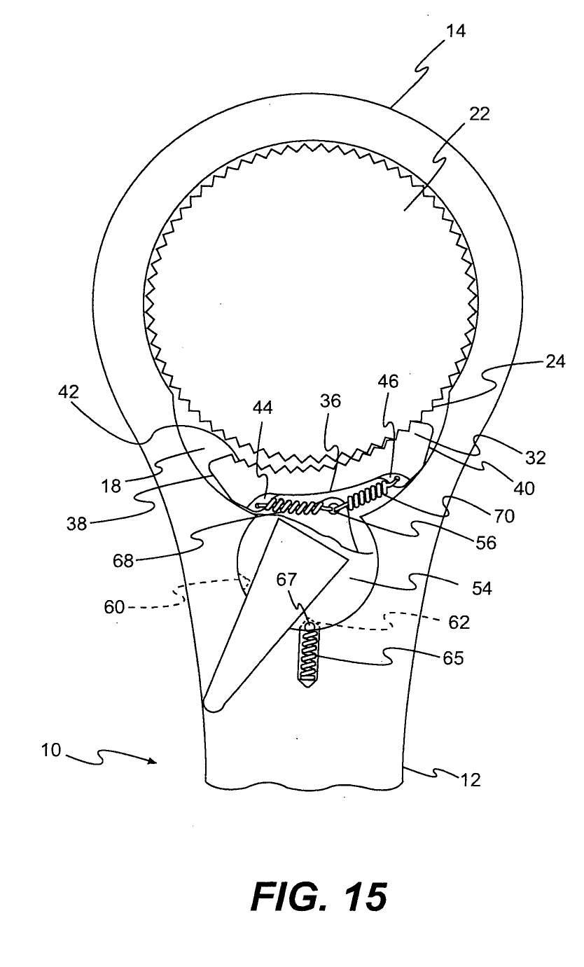

Reversing lever 54 is interconnected to pawl 32 by springs 68 and 70 (FIGS. 15-19) that allow the reversing lever to move the pawl within opening 18. One end of each of springs 68 and 70 connects to lever connector 56, and the other ends connect to connectors 44 and 46, respectively. In an alternate embodiment (not shown in the figures), a single spring may interconnect lever connector 56 with pawl connectors 44 and 46. Thus, the spring may be a single spring with the ends of the spring connected to pawl connectors 44 and 46 and the approximate midpoint of the spring connected to reversing lever connector 56. Moreover, the reversing lever may define a single connector 56 as shown in the figures, or the reversing lever may define two spaced-apart connectors. Any combination of these embodiments may also be used.

As previously noted, the connectors on either of pawl 32 or reversing lever 54 may be an opening in which an end of the spring(s) are received. In one embodiment, they may be a pin around which the ends of the spring are wrapped. In the embodiments shown in FIGS. 15 to 19, springs 68 and 70 connect pawl connectors 44 and 46 to a single lever connector 56. Pawl 32 (FIGS. 15-19) has a body outline defining pawl rear face 36 so that springs 68 and 70 are substantially nested within the recessed rear face. This configuration allows for springs 68 and 70 to be completely disposed within head opening 18 so that the forces primarily exerted on the pawl are rotational about the gear's axis of rotation.

An upper head surface 72 (FIG. 2) receives a cover plate 74 (FIGS. 2 and 4) that covers openings 16, 18, and 20 and retains the wrench parts within the head. A retaining ring or C-clip (not shown) is received in a groove (not shown) formed around the upper head surface 72 to secure cover plate 74 in place as is well known in the art.

Referring to FIGS. 15-18, the operation of ratcheting tool 10 will be described. FIG. 15 shows reversing lever 54 in a first predetermined position where ball 67 engages reversing lever pocket 62. In this position, spring 68 is under greater tension than spring 70, causing pawl 32 to slide counterclockwise in pocket 18. Thus, pawl side 40 contacts the wall of opening 18, and only a portion of pawl teeth 42, on pawl side 40, are engaged with gear teeth 24. The forces exerted by springs 68 and 70 act circumferentially with respect to the axis of rotation of ratcheting tool 10 so that pawl side 38 pivots away from gear 22 under the tension of spring 68. In this configuration, clockwise rotation of handle 12 drives gear 22 in the clockwise direction, and counterclockwise rotation of handle 12 causes pawl teeth 42 to ratchet over gear teeth 24, as further discussed below.

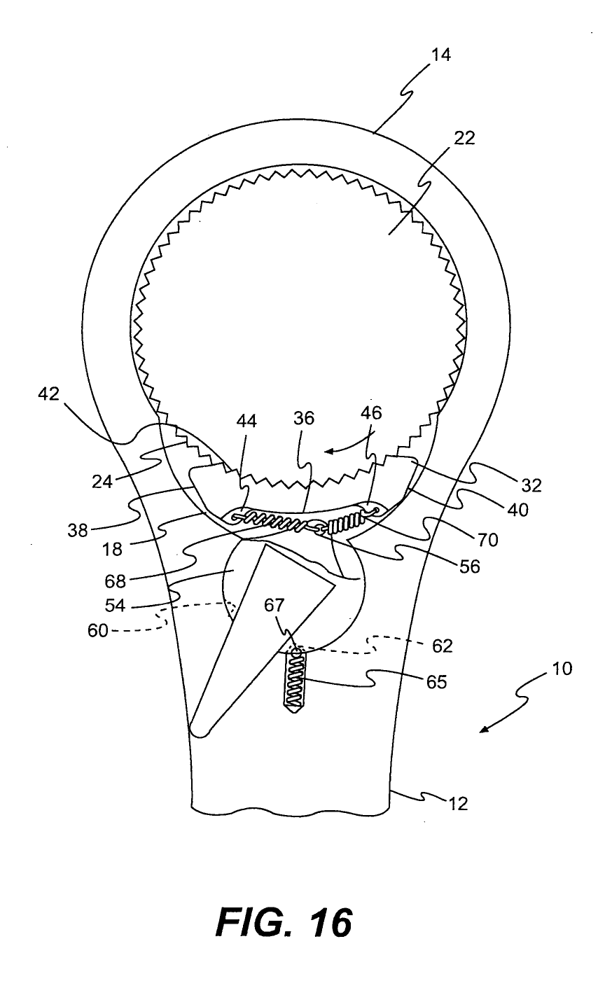

As shown in FIG. 16, rotating handle 12 clockwise changes the tension on springs 68 and 70, and spring 68 is placed under greater tension. Thus, spring 68 urges the non-abutting pawl side 38 toward gear 22 until the teeth on pawl side 38 abut the gear teeth. Thus, as gear 22 is driven, all of the pawl teeth are in engagement with the gear teeth so that maximum rotational loading can be exerted on the gear and workpiece. Alternately, during the backswing of handle 12 (counterclockwise rotation of handle 12), tension on spring 68 is reduced so that pawl end 38 again pivots away from gear teeth 24, leaving only a portion (one or two teeth) of pawl teeth 42 in contact with gear teeth 24. Consequently, the engaged portion of the pawl teeth ratchet over the gear teeth as pawl 32 is pushed back into opening 18.

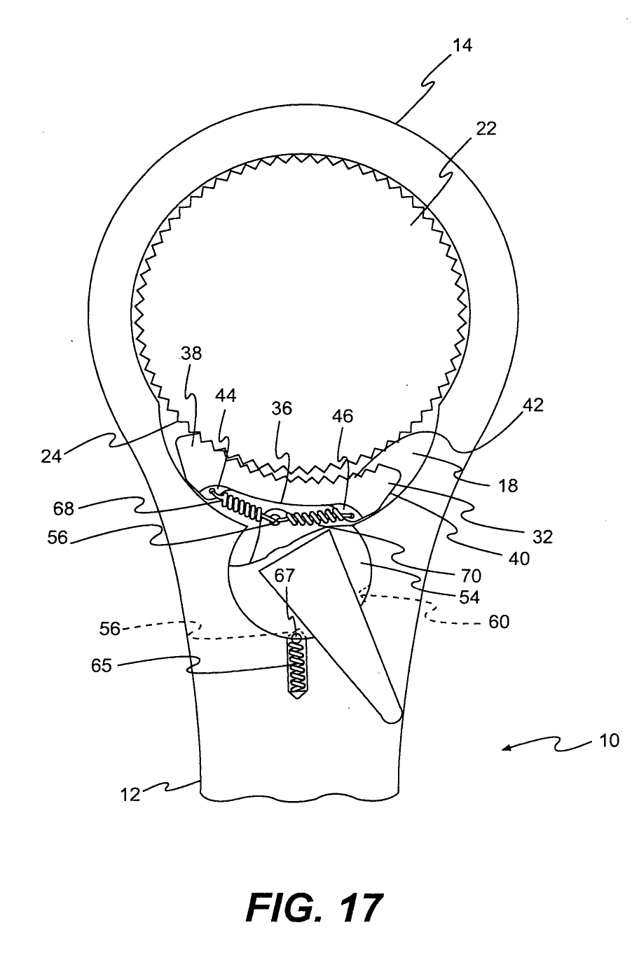

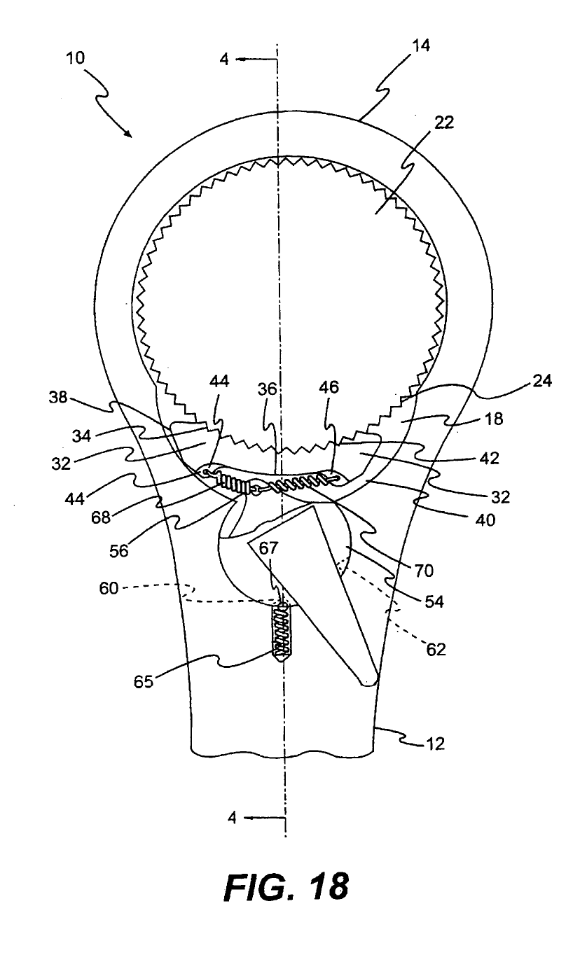

FIGS. 17 and 18 show similar action of gear 22 and pawl 32 when reversing lever 54 is disposed in a second predetermined position. Counterclockwise rotation of handle 12 places additional tension on spring 70, causing pawl end 40 to pivot into engagement with gear teeth 24 so that the wrench drives the gear and workpiece in the counterclockwise direction. Rotating handle 12 in the clockwise direction reduces the tension in spring 70, allowing pawl end 40 to again pivot away from gear 22 so that the gear teeth may ratchet over the pawl teeth.

The above described embodiment utilizes a fine gear tooth pitch and cooperating pawl tooth pitch. In the preferred embodiment, gear 22 has at least 72 teeth formed circumferentially about the gear. This facilitates use of the wrench of the present invention in confined spaces where a reduced backswing produces sufficient forward gear rotation.

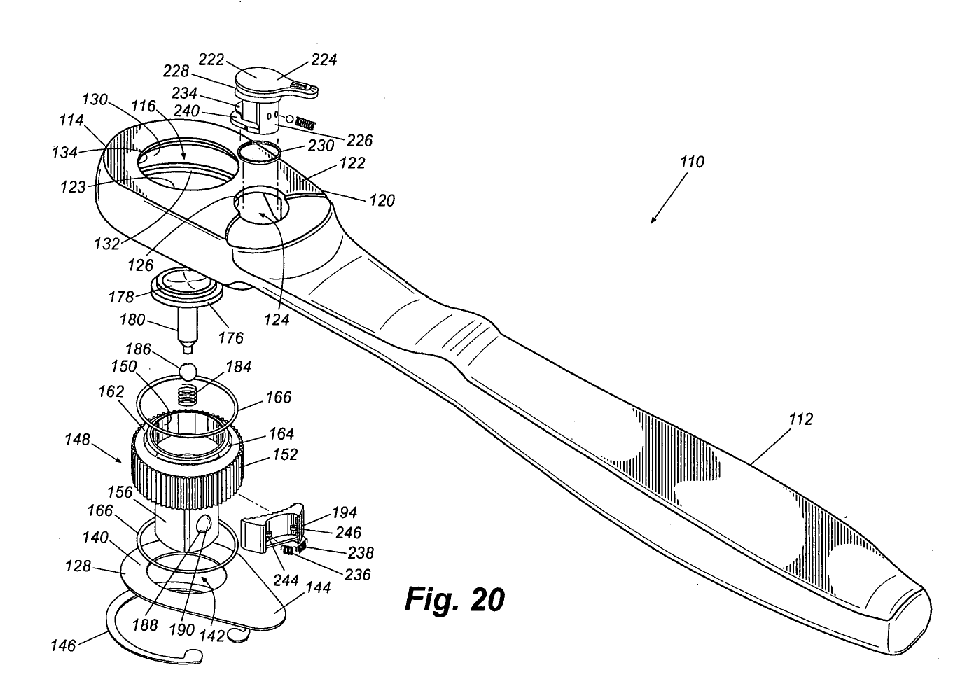

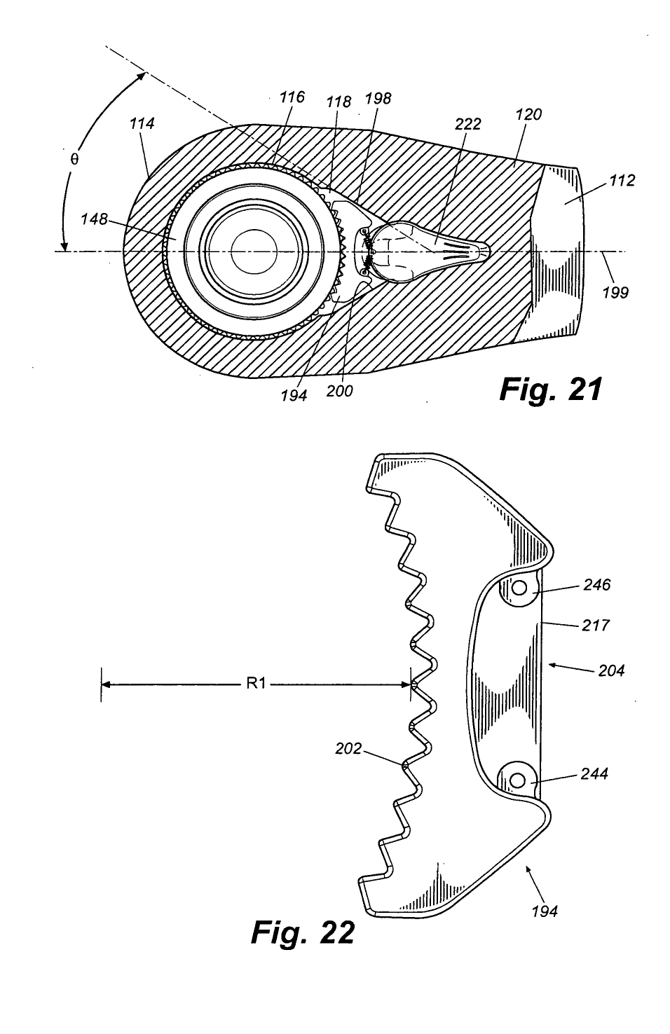

In yet another embodiment of the present invention, the sliding pawl may be used in a ratcheting wrench where the pawl has a radius that differs from the radius of the gear wheel as explained in more detail below. Referring to FIGS. 20 and 21, a ratcheting tool 110 includes an elongated arm, which may be formed as a handle 112 from stainless steel, metal alloys or other suitable materials. The length of handle 112 may vary depending on the application of ratcheting tool 110. A head 114 extends from the handle 112, and the head and handle may be integrally formed from the same material.

Head 114 defines a relatively large and generally cylindrical through-hole compartment 116. A web portion 120 is intermediate to head 114 and handle 112 and defines a smaller, wedge-shaped compartment 118. A generally cylindrical compartment 124 extends through a top face 122 into web 120 at a hole 126 and overlaps compartment 118. Compartment 118 is closed above by top face 122 and opens into both compartments 116 and 124. The underside of head 114 is open and receives a cover 128 that secures certain components of ratcheting tool 110 within compartments 116, 118 and 124, as described in greater detail below.

A wall 130 defines compartment 116 between a radially outward extending ledge 132 at one end and a radially inward extending ledge 134 at its other end. An annular groove (not shown) is defined in a vertical wall extending down from ledge 132 and surrounds most of compartment 116.

Cover 128 has an annular portion 140 defining a hole 142 and a tab portion 144 extending from annular portion 140. An opening in the bottom of head 114 and web 120, a portion which is shown in FIG. 20, receives cover 128 so that annular portion 140 sits on ledge 132. The annular groove (not shown) receives a C-clip 146 to secure cover 128 between the C-clip and ledge 132 so that cover 128 is held in position over compartments 116, 118 and 124.

As shown in FIGS. 24-25A, compartment 116 receives an annular gear ring 148 having an inner surface 150 that is concentric with wall 130 of head 114. The outer circumference of gear ring 148 defines a series of vertically-aligned teeth 152. The gear ring's bottom side defines an extension portion 156 surrounded by a flat annular shoulder 158 that defines an annular groove 160. On the top side, a top ledge 162 surrounds an upwardly extending wall 164. Gear ring 148 fits into compartment 116 so that wall 164 extends through a hole 123 in top face 122 and so that ledge 162 abuts ledge 134. When cover 128 is secured to head 114, extension portion 156 extends through hole 142, circular portion 140 abuts shoulder 158, thereby retaining gear ring 148 in compartment 116.

Extension portion 156 and wall 164 fit through respective holes 142 and 123 with sufficient clearance so that the gear ring is secured in the radial direction yet is permitted to rotate with respect to head 114. A lower O-Ring 166 (FIG. 20) is received in annular groove 160 and abuts cover 128, while an upper O-ring extends around wall 164 between the ledges and 162. The O-rings aid in smooth rotation of gear ring 148 and minimize the amount of dirt and debris that can enter compartment 116. O-Rings 166 may be formed from pliable rubbers, silicones, metals, or other suitable material.

Extension portion 156 is square shaped in cross-section and is adapted to receive a standard three-eighths (⅜) inch drive socket, which should be well understood in the art. Extension 156 may also be sized to fit one-quarter (¼) inch drive, one-half (½) inch drive, or other drive size sockets as desired.

Inner surface 150 of gear ring 148 surrounds a blind bore 168 centered around the axis of gear ring 148. Bore 168 receives a push button 176 having an annular top 178 and a cylindrical shaft 180. The top end of bore 168 defines a shoulder 182 that is peened inward to retain button 176 in the bore. A spring 184 and ball 186 in the bottom of bore 168 bias button 176 upward against shoulder 182. A cylindrical bore 190 intersects bore 168 at a right angle and receives a ball 192. An edge 188 of bore 190 is peened inward to retain the ball in the bore.

Ball 186 controls the position of ball 192 within bore 190. Normally, when spring 184 and ball 186 push the top of button 176 up against shoulder 182, ball 186 is aligned with ball 192, thereby pushing ball 192 out against bore edge 188. In this position, a portion of ball 192 extends out of bore 190 to retain a socket on extension 156. To remove the socket, the operator pushes push button 176 down against spring 184 (FIG. 25A). This moves ball 186 below bore 190 and aligns a narrowed end of shaft 180 with ball 192, thereby allowing ball 192 to move back into bore 190 to release the socket.

Referring to FIGS. 21-23, compartment 118 receives a generally wedge-shaped pawl 194 between side walls 198 and 200. Cover 128 and top face 122 of web 120 retain pawl 194 from below and above. Walls 198 and 200 are formed so that vertical planes (i.e. planes perpendicular to the page) defined by the walls intersect a vertical plane 199 that passes through the center of compartments 116 and 124 (see FIG. 21) at an angle θ such that compartment 118 optimizes the load-bearing and ratcheting capabilities of ratcheting tool 110. The size of angle θ may vary depending on the tool's intended use. A larger angle, for example, allows for greater load-carrying characteristics between gear ring 148 and pawl 194, while a smaller angle provides for better ratcheting and reversing. Thus, the angle chosen in a given instance preferably provides the best combination of gear/pawl tooth loading and clearance for the pawl during ratcheting and reversing. In a preferred embodiment, angle θ between plane 199 and each of side walls 198 and 200 is 31 degrees and is preferably within a range of 27 degrees to 35 degrees.

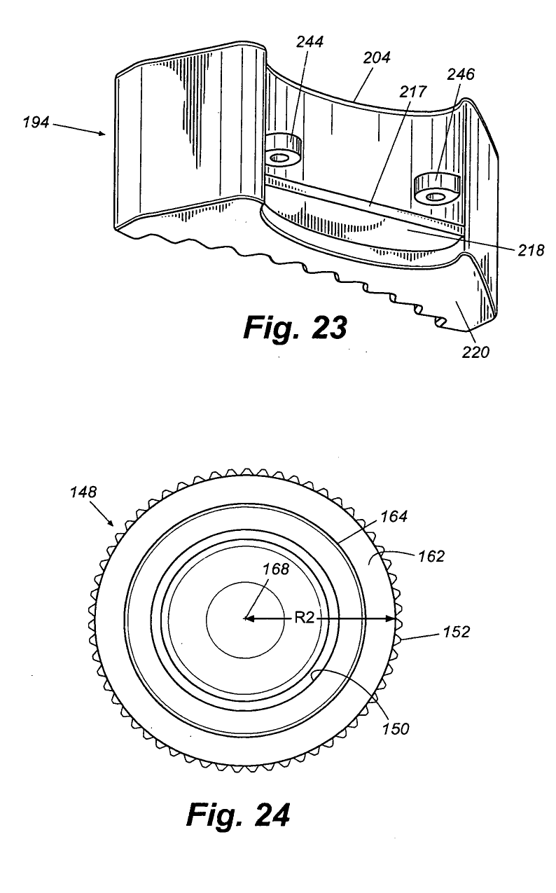

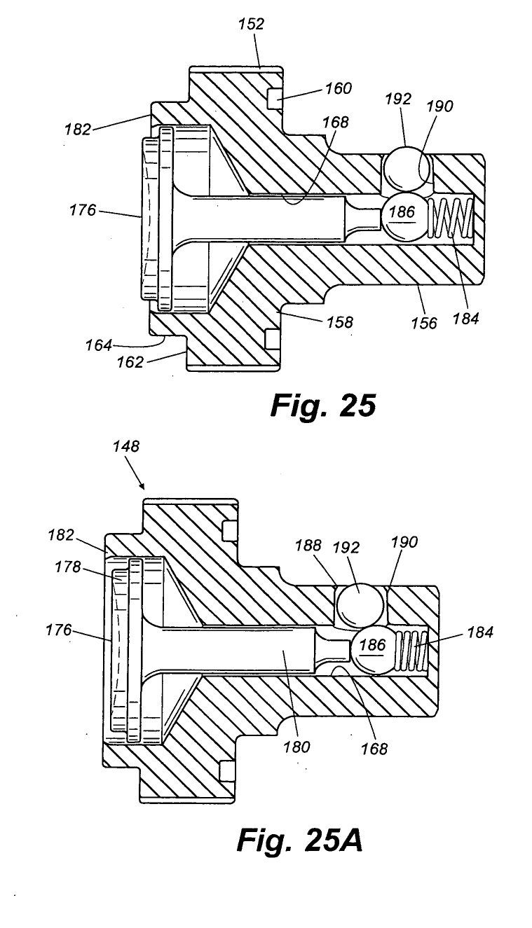

As shown in FIGS. 22 and 23, pawl 194 defines a plurality of vertically-aligned teeth 202 across the pawl's front face in an arc having a radius R1 and two connectors 244 and 246 in the back face 204 of the pawl. A ledge 217 is formed in back face 204 proximate the bottom of pawl 194 to form a notched area 218. Ledge 217 helps to retain a reversing lever 222 in ratcheting tool 110 as discussed below.

In the illustrated embodiment, the tips of the teeth are rounded slightly, and R1 is measured to the rounded tips of the teeth. The radius R1 is different than a radius R2 (FIG. 24) between the center 168 of gear ring 148 and the troughs of its teeth 152. Because of manufacturing tolerances, the tips of the pawl teeth and the troughs of the gear teeth vary slightly in the radial direction, as should be understood in this art. Thus, radii R1 and R2 should be understood to lie within the pawl and gear tolerance ranges and are assumed to extend to the mid-points of the respective tolerance range for purposes of this discussion. Furthermore, it should be understood that radii R1 and R2 may be taken at other locations on the gear and the pawl, for example at the tips of the gear teeth and the troughs of the pawl teeth.

Referring to FIG. 20, reversing lever 222 includes a handle portion 224 and a bottom portion 226. The outer surface of bottom 226 defines an annular groove 228 that receives an O-ring 230, which extends slightly outward of groove 228. Bottom 226 also defines a connector 234 that receives the ends of springs 236 and 238 (FIG. 21). Hole 126 in web 120 receives the lever's bottom portion 226. The diameter of bottom portion 226 is approximately equal to the diameter of hole 126, although sufficient clearance is provided so that the reversing lever rotates easily in the hole. Upon insertion of bottom portion 226 into hole 126, the hole's sides push O-ring 230 radially inward into groove 228 so that the O-ring thereafter inhibits the entrance of dirt into the compartment. A radially outward extending lip 240 at the bottom of the lever fits into notch 218 so that ledge 217 axially retains lever 222 in its compartment. Referring also to FIG. 21, the other end of springs 236 and 238 are received in respective connectors 244 and 246.

In operation, ratcheting tool 110 operates under the same principles as ratcheting tool 10. Therefore, a discussion of the operation of ratcheting tool 110 will not be discussed herein.

As indicated previously, the radius R1 of a curve defined by the tips of the pawl teeth is larger than the radius R2 (FIG. 24) of a curve defined by the troughs of the gear teeth. The ratio of R1 to R2 is preferably within a range of 1:1.08 to 1:1.3. In the example shown in FIGS. 20-21, the ratio is 1.0 to 1.12, where radius R1 equals 0.458 inches. The depth of the gear teeth and the pawl teeth is approximately 0.020 inches.

Preferably, the gear teeth are formed uniformly about the gear's circumference. The depth of each tooth, which may be defined as the distance along a radius of the gear extending between the tooth's tip and an arc connecting the troughs beside the teeth, is the same. The internal angle between the sides of a tooth (the “included” angle) is the same for each tooth, and the angle between sides of adjacent teeth (the “adjacent” angle) is the same for each pair of adjacent teeth.

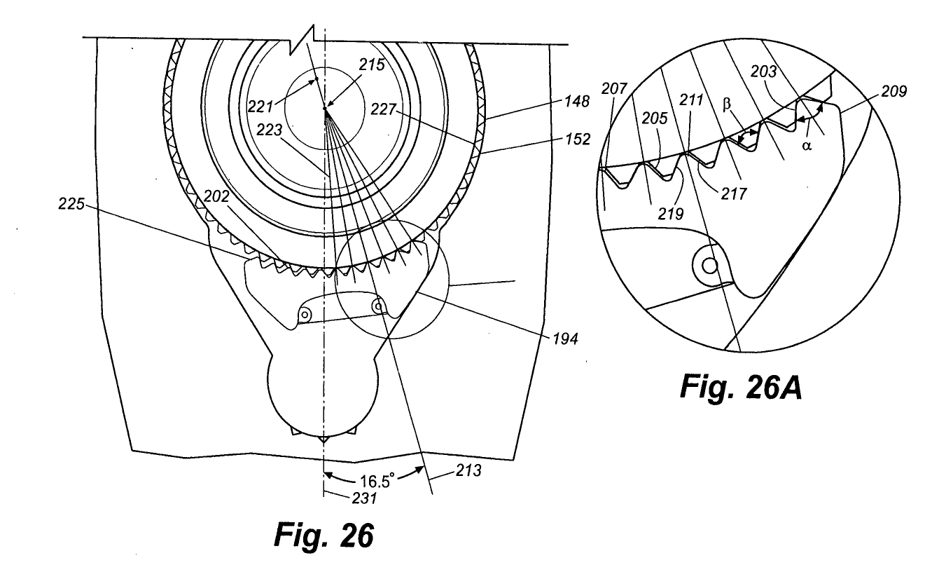

The dimensions of the pawl teeth, and the ratio between gear radius R2 (FIG. 24) and pawl radius R1 (FIG. 22), may be determined by modifying an initial assumption that the pawl teeth will exactly fit the gear teeth. That is, the depths and the included and adjacent angles of the pawl teeth initially match the corresponding dimensions of the gear teeth. Referring to FIGS. 26-26A, both sides of each pawl tooth are then pivoted (for example, using a computer-aided design (“CAD”) system) toward each other by 1.5 degrees about the tooth's theoretical tip, thereby reducing the tooth's included angle by approximately 3 degrees. The non-loaded side 205 of each of the three outermost teeth on each side of the pawl is then shaved by 0.003-0.005 inches, and the tips of the teeth are rounded. The degree of rounding increases from the outermost teeth to the pawl center so that the rounded tips define a common radius (within manufacturing tolerances). As will be appreciated, this procedure results in a slightly non-flush engagement between the load-bearing sides 203 of the pawl teeth and the opposing gear tooth sides.

Because the pawl radius R1 (FIG. 22) is larger than the gear radius R2 (FIG. 24), the included angles α and adjacent angles β of the pawl teeth are not uniform, as can be seen in FIG. 26A. The variation results from pivoting the pawl teeth's non-load-bearing sides 205 so that the included angle α of each tooth is reduced by a desired amount (preferably one to two degrees) less than the included angle of the gear teeth. This adjustment results in a slight gap between the non-load-bearing gear teeth sides and the non-load-bearing pawl teeth sides 205. The gap reduces or eliminates fluid adhesion (caused by grease or oil in the mechanism) and taper fit between the gear and pawl teeth, thereby facilitating smooth removal of the pawl teeth from the gear teeth during ratcheting and pawl reversal. FIG. 26A illustrates the pawl teeth to one side of a center tooth 207. The positions of the teeth on the opposite side of tooth 207 are a mirror image of the illustrated side and are therefore not shown.

It should be understood that a ratio of the gear diameters is used to scale the dimensions of the pawl, reversing lever, ratchet head, and other ratchet components. The gear diameter for determining the ratio is measured between the tips of the gear teeth. When determining the ratio of the pawl radius to the gear radius, R1 is measured to the tips of the pawl teeth (FIG. 22), and R2 is measured to the troughs of the gear teeth (FIG. 24).

The gear/pawl radius ratio may vary among tools of different sizes, but the ratio may also vary among tools of the same size. That is, the particular ratio for a given tool may be selected independently of other tool designs, preferably within a range of 1:1.08 to 1:1.3. A ratio for a particular tool design may be determined by trial and error, but it is believed that the two primary factors determining an appropriate range for the radius ratio are (1) the gear radius and (2) the depth of the teeth on the gear and the pawl. Once these parameters are chosen, a radius ratio may be selected on a CAD system or other graphic means through an alternate method described below.

FIGS. 26 and 26A represent a CAD depiction of a gear 148 and a pawl 194. The operation of CAD systems should be well understood in this art and is therefore not discussed herein. Initially, the pawl and gear are disposed so that they face one another. The body of the ratchet wrench head is illustrated for purposes of context but is preferably omitted from the CAD drawing. The theoretical (i.e. non-rounded) tip of each pawl tooth lies on a respective line 223 that passes through the center 215 of gear 148 and the trough between the opposing gear teeth on the loaded side of the pawl. The included angles α are consistent across all pawl teeth and are the same as the gear teeth adjacent angles. The depth of the pawl teeth is the same as the depth of the gear teeth, and all teeth are as yet not rounded. An initial gear/pawl radius ratio is selected arbitrarily. The adjacent angle β depends on the selected initial radius ratio but is the same for all pawl teeth. If a 1:1 ratio is selected, the pawl's adjacent tooth angle β is the same as the adjacent angle between the gear teeth.

Next, a pivot tooth is selected on one side of the pawl's center tooth. Preferably, the pivot tooth is the principal load-bearing tooth. The particular number of load-bearing teeth on either pawl side depends on the density of teeth on the pawl, the design of the back of the pawl and the design of the compartment wall against which the pawl sits. Given a design where these factors are known, the load-bearing teeth may be identified by applying very high loads to a ratchet and observing which teeth are first to shear or by simply assessing the design from experience with prior designs. In the embodiment shown in FIGS. 26 and 26A, the load-bearing teeth are the four outermost teeth inward of pawl end 209, and the pivot tooth is preferably tooth 211—the closest one of these teeth to center tooth 207.

After selecting the pivot tooth, the pawl is moved so that pivot tooth 211 is received in exact alignment with the gap between adjacent teeth 217 and 219 on the gear. That is, tooth 211 is fully received in the gap between teeth 217 and 219, and its sides 203 and 205 are flush against the opposing sides of teeth 217 and 219, respectively. If the initial radius ratio is not 1:1, the pivot tooth is the only tooth that fits exactly between its opposing gear teeth. The teeth on either side of the pivot tooth are increasingly misaligned with the gaps between their opposing gear teeth.

The final pawl radius is defined along a radius line 213 that includes center 215 of gear 148 and the non-rounded tip of the pivot tooth. A point 221 on line 213 is initially defined as the center of curvature of the non-rounded tips of the pawl teeth as originally drawn on the CAD system. That is, point 221 is the origin of the pawl radius, and the pivot tooth defines the point at which an arc defined by the gear radius is tangent to an arc defined by the pawl radius. To determine the final pawl radius (in this instance, the radius to the theoretical tips of the pawl teeth), point 221 is moved along line 213 behind point 215. The adjacent angles β between the pawl teeth change in accordance with the changing pawl radius. The pawl teeth depth and included angles, as well as the alignment of the pivot tooth in the gap between its opposing gear teeth, remain fixed. As point 221 moves closer to gear center point 215 along line 213, the pawl radius decreases, and the pawl teeth on either side of the pivot tooth move closer into the gaps between the opposing gear teeth. Conversely, the pawl radius increases as point 221 moves away from center point 215, and the pawl teeth on either side of the pivot tooth move away from the gear teeth. Preferably, point 221 is selected so that the non-rounded tip of the outermost tooth 225 on the opposite side of center tooth 207 from the pivot tooth is within one-half to fully out of the gap between its opposing gear teeth. That is, assume that an arc defined by troughs 227 between the gear teeth is assigned a value of zero and that an arc defined by the gear tooth tips is assigned a value of 1. The tip of pawl tooth 225 preferably is disposed within a range including and between two intermediate arcs located at 0.50 and 1.0.

Once the pawl radius, and therefore the gear/pawl radius ratio, has been determined, the pawl teeth are modified to their operative dimensions. The pawl remains located by the CAD system in the wedged position against the gear as shown in FIG. 26, and the pivot tooth remains in exact alignment with its opposing gear teeth. The non-loaded side 205 of each tooth, including the pivot tooth, is pivoted about the tip of the tooth so that the tooth's included angle is preferably one to two degrees less than the adjacent angle of the gear teeth. The side of the center tooth facing the loaded pawl teeth is adjusted in this step as a non-loaded side. The load-bearing sides 203 are not adjusted. Thus, except for the pivot tooth, the load-bearing sides of the pawl teeth are slightly out of flush with their opposing gear tooth sides.

This defines the dimensions of the gear teeth on one side of the pawl. The teeth on the other pawl side are then adjusted to be the mirror image (across the pawl's center line) of the first side. The pawl (and gear) teeth are rounded as desired. As indicated in FIG. 22, the rounded tips preferably remain on a common arc.

At this point, the pawl tooth design is complete, and a pawl with the selected dimensions may be operated in a tool as shown in FIG. 20. In particular, the selection of the pawl radius so that the tip of the outermost non-loaded tooth is one-half to fully out of the gear teeth generally assures that when one side of the pawl or the other is wedged in the pawl compartment in engagement with the gear, only the teeth on that side are loaded against the gear teeth. The teeth on the trailing side remain unloaded.

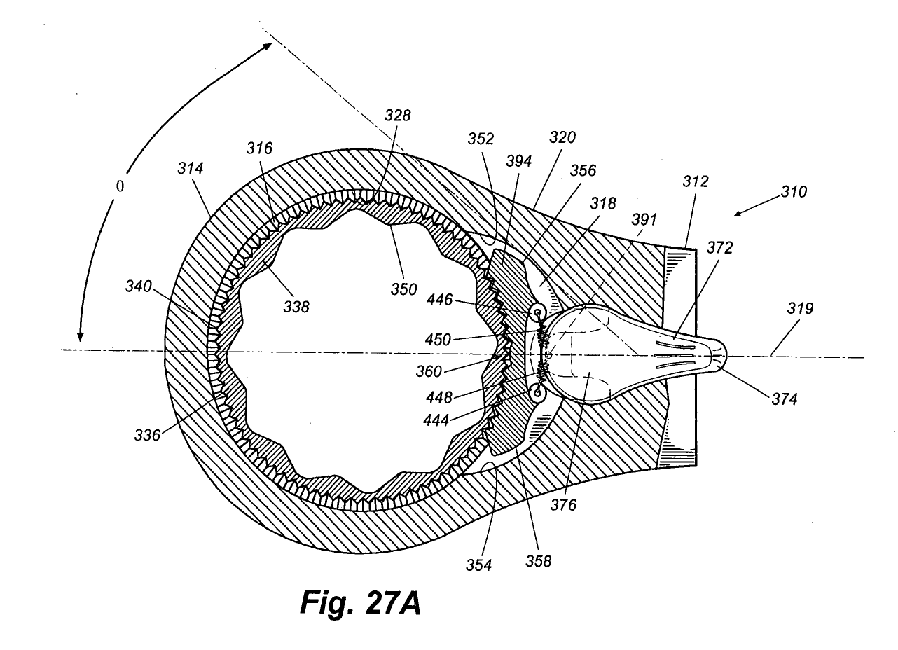

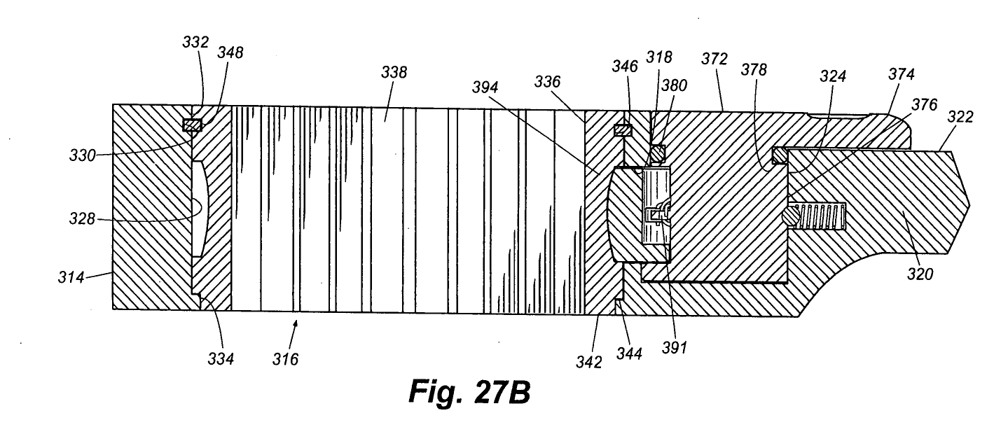

Although the discussion above describes a gear/pawl arrangement in a ratchet, it should be understood that the present invention may encompass other ratcheting tools, for example a ratcheting wrench as shown in FIGS. 27A and 27B. Generally, ratcheting tool 310 operates under the same principles as ratcheting tool 10 (FIG. 1).

Ratcheting tool 310 includes a handle 312 and a head 314 extending from the handle, which may be formed from a suitable material such as stainless steel or a metal alloy. Handle 312 may be a solid piece and has a generally rectangular transverse cross-section, although the length and cross-sectional shape of handle 312 may vary as desired.

Referring to FIGS. 27A and 27B, head 314 includes a wall 328 that defines a generally cylindrical through-hole compartment 316. A smaller, semi-circular compartment 318 is defined in a web portion 320 intermediate head 314 and handle 312. A generally cylindrical compartment 324 extends through face 322 into web 320 and overlaps compartment 318. Compartment 318 is closed above and below by top and bottom surfaces of web 320, and compartment 318 opens into both compartments 316 and 324. A groove 330 about compartment 316 extends into head 314 from wall 328 proximate the top edge of the wall for receipt of a C-clip as discussed below. An annular ledge 334 extends radially inward into compartment 316 from wall 328 proximate the wall's bottom edge.

Compartment 318 differs from the pawl compartment described above in ratcheting tool 110 (FIG. 20) in that both the top and bottom faces of head 314 are closed over the compartment. Compartment 318 may be formed by a key-way cutter or a computer numeric controlled (CNC) milling machine that cuts compartment 318 with a cutting tool inserted into compartment 316. The cutting tool has a shaft with a disk-shaped cutter at the end of the shaft, and cutting edges are formed about the disk's circumference. The disk's radius is greater than the depth of compartment 318 between compartments 316 and 324, and the disk's height is less than the thickness of web 20. The tool is initially inserted into compartment 316 so that the tool's axis passing through the center of the disk and the shaft is parallel to the axis of cylindrical compartment 316. That is, the cutting disk is generally coplanar with the compartment.

Referring to FIG. 27A, compartment 316 receives a gear ring 336. The gear ring has an inner surface 338 that is concentric with wall 328 and that defines a plurality of aligned flats 350 spaced equiangularly about inner surface 338 to engage the sides of a bolt, nut or other work piece. The outer circumference of gear ring 336 defines a series of vertically-aligned teeth 340. A bottom side of gear ring 336 defines an extension portion 342 surrounded by a flat annular shoulder 344. Extension portion 342 fits through ledge 334 so that shoulder 344 sits on the ledge and retains gear ring 336 in the lower axial direction. Extension portion 342 fits through ledge 334 with sufficient clearance so that the ledge secures the gear ring in the radial direction yet permits the gear ring to rotate with respect to head 314.

Gear ring 336 defines an annular groove 346 about its outer surface proximate its upper end. A C-ring 348 extending from groove 346 is compressed inward into the groove as the gear ring is inserted into the head. When grooves 330 and 346 align, the C-ring snaps into groove 330, thereby securing gear ring 336 in the upper axial direction.

A pawl 394 is received in compartment 318 so that the top and bottom surfaces of compartment 318 retain the pawl from above and below. Pawl 394 defines two connectors 444 and 446 on its rear face in the form of a flange containing a hole. A reversing lever 372 includes a handle portion 374 and a bottom portion 376 extending below the handle portion. Bottom 376 defines a connector 391 that receives one end of springs 448 and 450. Connectors 444 and 446 receive the other ends of respective springs 448 and 450.

Compartment 324 receives lever bottom portion 376. The outer diameter of bottom portion 376 is approximately equal to the inner diameter of compartment 324, although sufficient clearance is provided so that the reversing lever rotates easily in the hole. Rotation of the lever moves the pawl across compartment 318 between its two wedged positions in the same manner as discussed above with respect to ratcheting tool 10.

Similarly to ratcheting tool 110, the wrench illustrated in FIGS. 27 and 27A may be manufactured to different sizes. The size is denoted by the size of the work piece received within the gear so that flats 350 engage and apply torque to the work piece. That is, for example, a 1/4 inch wrench can turn a 1/4 inch fastener.

As with ratcheting tool 110, the sizes of the gear and the pawl in the wrench vary with the size of the overall tool. In one preferred embodiment, the tooth depth on both the gear and the pawl is approximately 0.012 inches. As with ratcheting tool 110, the tips of the pawl teeth define a curve having a radius that is larger than a radius of a curve defined by the troughs of the gear teeth. The ratio of the gear radius to the pawl radius for a given wrench may be determined in the same manner as described above and is preferably within range of 1:1.08 to 1:1.3. In one preferred embodiment of a one-quarter inch drive ratchet wrench, the gear/pawl radius ratio is 1:1.09. In exemplary five-sixteenth, one-half, five-eighths, and three-quarter inch wrenches, the ratio in each wrench is within the range of 1:1.08 to 1:1.30.

As is apparent by a comparison of FIGS. 20 and 21 and FIGS. 27 and 27A, ratcheting tool 110 and the ratcheting tool 310 differ in the shape of their pawl compartments and in that the pawl compartment of the socket ratchet is enclosed by a separate cover plate, whereas the pawl compartment of the drive ratchet wrench is enclosed on top and bottom by the web. There is also a difference in the shape of the pawl compartments and, as described in more detail below, in the gear and pawl profiles. It should be understood, however, that these embodiments are presented by way of example only. Thus, for instance, it is possible to construct a drive ratchet with an open pawl compartment and a socket ratchet with a closed pawl compartment.

Returning to FIGS. 27 and 27A, the difference in the shape of compartment 318 results in a different construction of the rear portion of the pawl. For example, compartment 318 is shallower than the compartment shown in the tool of FIGS. 20 and '21, and the pawl is therefore narrower from front to back. In addition, the curved walls of compartments 318 at areas 352 and 354, at which pawl surfaces 356 and 358 engage the compartment when the pawl is wedged between the compartment wall and the gear, define a different curve. In an alternate embodiment, however, the cutting tool flattens wall areas 352 and 354 after the initial key-way cut so that a plane defined by each surface (i.e. a plane perpendicular to the page) defines a desired angle θ with respect to the tool's center line 319, as indicated in FIG. 27A. In a preferred embodiment, this angle is preferably within a range of 27° to 35°, for example approximately 31°.

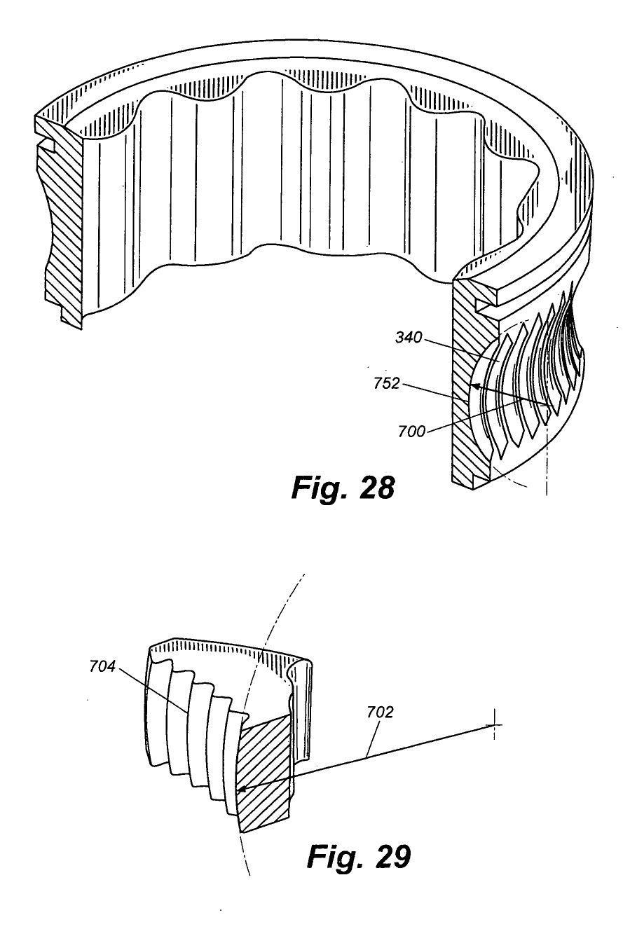

In addition, FIGS. 27A and 27B illustrate that the gear and pawl teeth do not extend straight from the top to the bottom of the gear and pawl. That is, the gear's outer surface is concave, and the gear teeth extend vertically between the top and bottom of the gear in an inward curve. Correspondingly, the pawl teeth are convex between the top and the bottom of the pawl face. Thus, FIG. 28, which illustrates a perspective view of a section of the gear, illustrates the gear teeth curving outward toward the gear's top and bottom edges. In this configuration, the pawl face is formed in a correspondingly convex shape so that the pawl teeth extend between the top and bottom of the pawl in an outward curve (FIG. 29) to interengage with the gear teeth.

As discussed above, the pawl teeth are disposed on an arc that defines a radius greater than the radius of the gear teeth. In defining the radius ratio, the gear tooth radius and pawl tooth radius are preferably considered at a plane passing mid-way between the top and bottom halves of the gear and the pawl.

As also indicated in FIG. 27, the center two pawl teeth may be eliminated to form a bridge 360. This does not affect the design of the teeth on either side of the bridge. For example, a full set of pawl teeth may be designed as discussed above, with an additional step of eliminating the center or, if the pawl's center line runs between two teeth instead of a single center tooth, the two center teeth. As should be understood in this art, the center teeth perform little or no work. It is believed that their removal may facilitate the pawl's ratcheting and transition movements.

Referring particularly to FIGS. 28 and 29, a radius 700 of the arc extending between opposite axial edges of the gear and defined by the troughs between concave vertical gear teeth 752 may be equal to a radius 702 of the arc extending between top and bottom sides of the pawl face and defined by the edges of convex vertical pawl teeth 704. However, to allow for the effects of manufacturing tolerances in the alignment of the vertical teeth on the gear and the pawl, and of twisting deformation of the gear under high torque loads, the pawl's convex radius 702 is preferably less than the gear's concave radius 700. In an embodiment of a three-quarter inch drive ratchet wrench, for example, concave gear radius 700 is 0.236 inches, while convex pawl radius 702 is 0.200 inches. This arrangement permits effective operation of the wrench even if the gear and/or pawl teeth are as much as 0.015 inches out of vertical alignment. It should be understood that such a mismatch between the concave vertical gear radius and the convex vertical pawl radius may be practiced regardless of the relationship between the circumferential radii of the gear teeth and the pawl teeth. That is, the concave and convex radii may be different regardless whether the radius defined by an arc connecting the troughs of the gear teeth is equal to or different from the radius defined by an arc connecting the tips of the pawl teeth.

Additionally, it should be understood that the concave and convex radii of the gear and the pawl, respectively, may be defined at any suitable position on the gear and the pawl that oppose each other when the pawl teeth engage the gear teeth. Thus, for example, the concave gear radius may be defined at the edge of the gear teeth while the convex pawl radius may be defined at the troughs between the pawl teeth.

Furthermore, the construction of the ratcheting tool may affect the extent or the desirability of a mismatch between the concave and convex radii of the gear and the pawl. For example, a gear in a tool as shown in FIG. 27A, in which the gear is retained from the top by a C-clip, may be subject to greater twisting deformation than a gear retained from the top by the tool head itself because the latter construction exerts greater resistance against forces in the upward direction typically applied through the gear when the tool is in use. Accordingly, while a mismatch between the profile radii of the gear and the pawl may be employed in either arrangement, it is particularly desirable in a construction in which the gear is retained from the top by a retainer other than the wrench body, such as in the embodiment shown in FIG. 27A.

As discussed above, the definition of a ratio between the gear radius and the pawl radius that is less than 1:1 (i.e., the gear radius is less than the pawl radius) facilitates the pawl's removal from the gear when the pawl transitions from one side of the pawl compartment to the other.

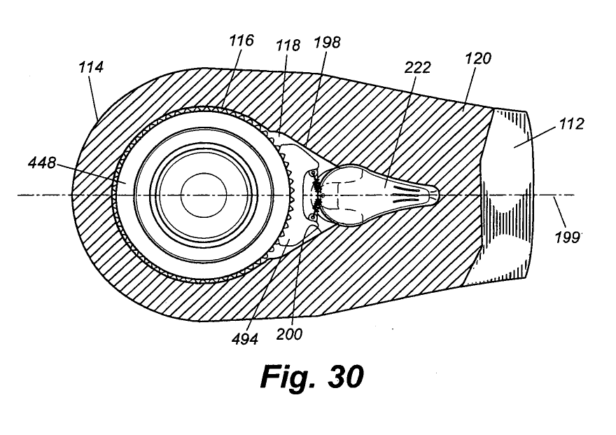

In yet another embodiment of the present invention, FIG. 30 shows a ratcheting tool that is similar to the ratcheting tool shown in FIG. 20, except that the radius of pawl 494 is equal to the radius of gear 448. That is, the pawl teeth completely engage the gear teeth as shown in the figure. Other than the radii of the pawl and the gear being equal, all other aspects of the ratcheting tool are similar to that shown in FIG. 20. Consequently, the ratcheting tool shown in FIG. 30 operates substantially the same as that shown in FIG. 20, and a discussion of the operation is omitted.

While one or more preferred embodiments of the invention have been described above, it should be understood that any and all equivalent realizations of the present invention are included within the scope and spirit thereof. The embodiments depicted are presented by way of example only and are not intended as limitations upon the present invention. Thus, it should be understood by those of ordinary skill in this art that the present invention is not limited to these embodiments since modifications can be made. Therefore, it is contemplated that any and all such embodiments are included in the present invention as may fall within the scope and spirit thereof.

1. In a ratchet wrench having two modes of operation, said ratchet wrench comprising:
a. a reversing lever;
b. a sliding pawl having a recessed back face; and
c. a pair of springs, each spring having a pair of ends, one end of said springs being connected to said pawl, and the other end of said springs being connected to said reversing lever,
wherein said springs are substantially nested within said recessed back face of said pawl.

2. The ratcheting wrench of claim 1, wherein each spring is under tension, the tension on one spring exceeding the tension on the other spring in one mode of operation, and the tension on the other spring exceeding the tension on the one spring in the other mode of operation.

3. In a ratchet wrench having two modes of operation, said ratchet wrench comprising:
a. a reversing lever;
b. a pawl having a recessed back face; and
c. a spring having a pair of opposite ends, said spring ends being spaced apart and connected to said pawl wherein a midpoint of said spring connects to said reversing lever, thereby forming two spring segments,
wherein said spring is substantially nested within said recessed back face of said pawl.

4. The ratchet wrench of claim 3, wherein each spring segment is under tension, and the tension on one spring segment exceeds the tension on the other spring segment in one mode of operation, and the tension on said other spring segment exceeds the tension on said one spring segment in the other mode of operation.

5. A ratchet wrench comprising:
a. a handle defining a head, said head further comprising,
a first circular opening,
a second opening in communication with said first opening,
a third opening in communication with said second opening;
b. a gear received in said first opening and defining a plurality of teeth on an outer circumference of said gear;
c. a pawl received in said second opening and in operative engagement with said gear, wherein said pawl defines a first connector and a second connector; and
d. a reversing lever in operative engagement with said pawl by a first and a second spring, wherein said first spring is connected between said reversing lever and said first pawl connector and said second spring is connected between said reversing lever and said second pawl connector.

6. The ratchet wrench of claim 5, wherein rotation of said reversing lever to a first predetermined position causes said second spring to bias a first portion of said pawl teeth into engagement with said gear teeth so that rotation of said handle in a first direction drives said gear in said first direction and rotation of said handle in a second direction causes said gear teeth to ratchet over said first portion of said pawl teeth.

7. The ratchet wrench of claim 6, wherein rotation of said reversing lever to a second predetermine position causes said first spring to bias a second portion of said pawl teeth into engagement with said gear teeth so that rotation of said handle in said second direction drives said gear in said second direction and rotation of said handle in said first direction causes said gear teeth to ratchet over said second portion of said pawl teeth.

8. A ratchet wrench comprising:
a. a handle defining a head;
b. a gear received in said head;
c. a pawl having a recessed back wall defining a first connector and a second connector, said pawl received in said head and in operative engagement with said gear; and
d. a reversing lever received in said head and in operative engagement with said pawl by a spring having a pair of opposite ends, said spring ends connected to said pawl first and said pawl second connectors, wherein a midpoint of said spring connects to said reversing lever thereby forming two spring segments.

9. The ratchet wrench of claim 8, wherein said two spring segments are formed from a first spring and a second spring.

10. The ratchet wrench of claim 9, wherein said first and said second springs are substantially nested within said recessed back wall of said pawl.

11. A ratchet wrench having a handle defining a head, said ratchet wrench comprising:
a. a gear defining a plurality of teeth on an outer circumference thereof, said gear being received in said head and having a first radius;
b. a pawl slidably received in said head and in operative engagement with said gear, wherein a back end of said pawl defines a first connector and a second connector and a front face of said pawl defines a second radius and wherein said second radius is larger than said first radius; and
c. a reversing lever in operative engagement with said pawl by a spring connected between said reversing lever and said first and said second connectors.

12. The ratchet wrench of claim 11, wherein rotation of said reversing lever to said first predetermined position causes said spring to bias a first portion of said pawl teeth into engagement with said gear teeth so that rotation of said handle in a first direction drives said gear in said first direction and rotation of said handle in a second direction causes said gear teeth to ratchet over said first portion of said pawl teeth.

13. The ratchet wrench of claim 12, wherein when said reversing lever is in said second predetermined position, said spring biases a second portion of said pawl teeth into engagement with said gear teeth so that rotation of said handle in said second direction drives said gear in said second direction and rotation of said handle in said first direction causes said gear teeth to ratchet over said second portion of said pawl teeth.

14. The ratchet wrench of claim 11, wherein said spring is formed from a first spring and a second spring, wherein said first spring is connected between said first pawl connector and said lever connector, and wherein said second spring is connected between said second pawl connector and said lever connector.
